(19) United States
(12) Patent Application Publication
(10) Pub. No.: US 2021/0298883 A1
(43) Pub. Date: Sep. 30, 2021

(54) Automated Toothbrush Assembly

(71) Applicant: Phov Kong, Shakopee, MN (US)

(72) Inventor: Phov Kong, Shakopee, MN (US)

(21) Appl. No.: 16/834,445

(22) Filed: Mar. 30, 2020

(51) Int. Cl. A61C 15/00; A46B 5/00; A46B 13/02; A46B 9/02; A46B 9/04; A46B 13/00; A61C 17/22; A61C 17/26

(52) U.S. Cl. CPC A61C 15/00; A46B 5/0095; A46B 13/02; A46B 9/025; A61C 17/221; A46B 13/003; A61C 17/225; A61C 17/26; A46B 9/04

(57) ABSTRACT

An automated toothbrush assembly for brushing teeth includes a handle that is gripped for brushing teeth. A rotation unit is movably positioned within the handle and the rotation unit includes a drive shaft that extends outwardly through the handle. The rotation unit alternately rotates the drive shaft in a first direction and a second direction when the rotation unit is turned on. A plurality of brushing heads is provided and a respective one of the brushing heads is removably attachable to the handle to place the respective brushing head in mechanical communication with the drive shaft of the rotation. Each of the brushing heads includes a brush that has a conical shape to penetrate spaces between teeth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toothbrush devices and more particularly pertains to a new toothbrush device for brushing teeth.

### (2) Description of Related Art Including Information Disclosed Under 37 CFR 1.97 and 1.98

The prior art relates to toothbrush devices including a toothbrush with a resiliently flexible handle. The prior art discloses a powered toothbrush that includes a worm gear and a shaft with a flexible joint for rotating a brush. The prior art discloses a powered tooth brush that has a brush with a plurality of groups of bristles each being slanted toward each other to facilitate the bristles to pass between teeth. The prior art also discloses a powered tooth brush that includes a removable brushing head. The prior art further discloses a tooth brush that has a pair of sockets for insertably receiving brushing heads.

### BRIEF SUMMARY OF THE INVENTION

An embodiment of the disclosure meets the needs presented above by generally comprising a handle that is gripped for brushing teeth. A rotation unit is movably positioned within the handle and the rotation unit includes a drive shaft that extends outwardly through the handle. The rotation unit alternately rotates the drive shaft in a first direction and a second direction when the rotation unit is turned on. A plurality of brushing heads is provided and a respective one of the brushing heads is removably attachable to the handle to place the respective brushing head in mechanical communication with the drive shaft of the rotation. Each of the brushing heads includes a brush that has a conical shape to penetrate spaces between teeth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an automated toothbrush assembly according to an embodiment of the disclosure.

FIG. 2 is a perspective view of a plurality of brushing heads of an embodiment of the disclosure.

FIG. 3 is an exploded perspective view of an embodiment of the disclosure.

FIG. 4 is a front view of an embodiment of the disclosure.

FIG. 5 is a right side view of an embodiment of the disclosure.

FIG. 6 is a cross sectional view taken along line 6-6 of FIG. 5 of an embodiment of the disclosure.

### DETAILED DESCRIPTION OF THE INVENTION

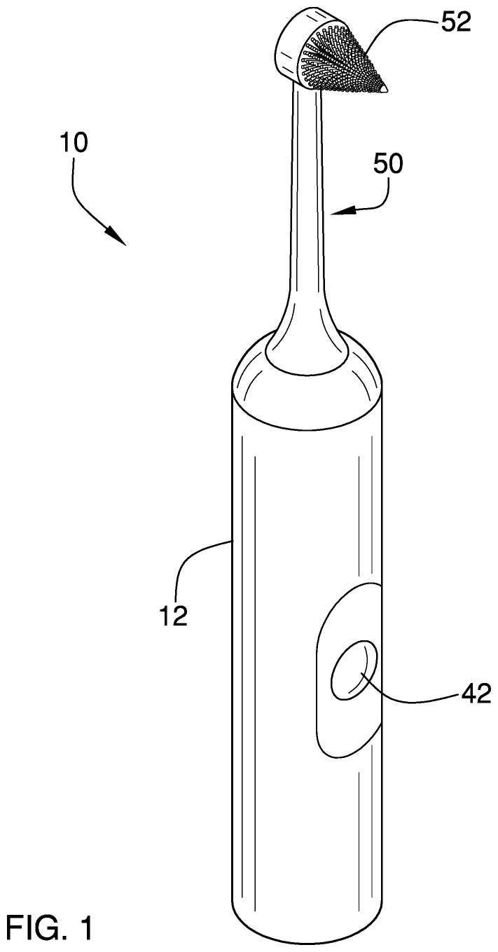

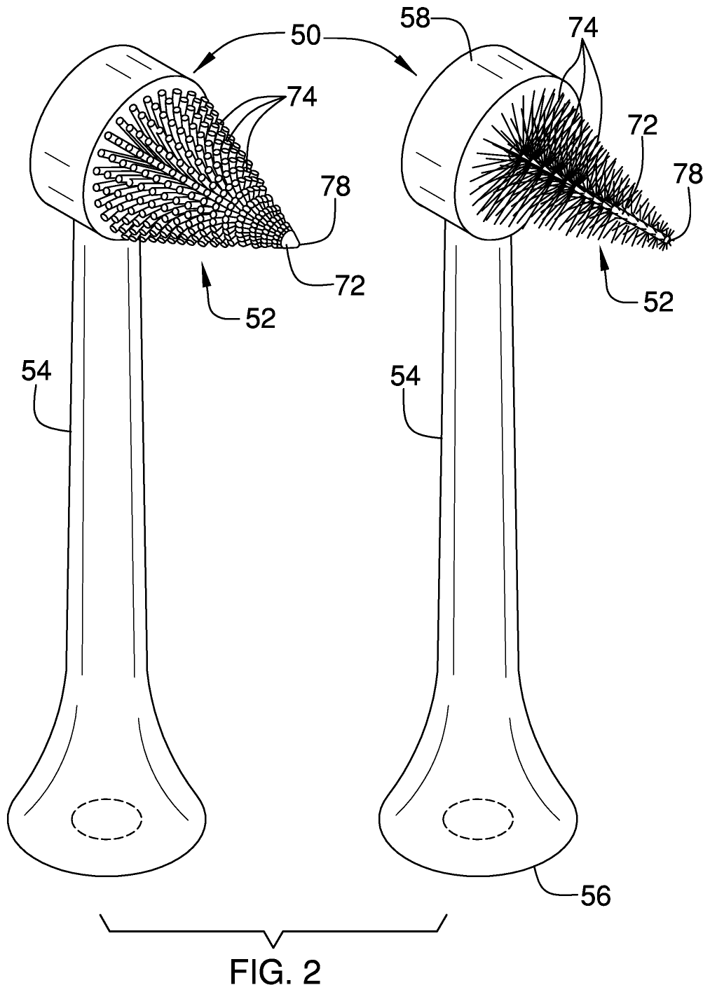

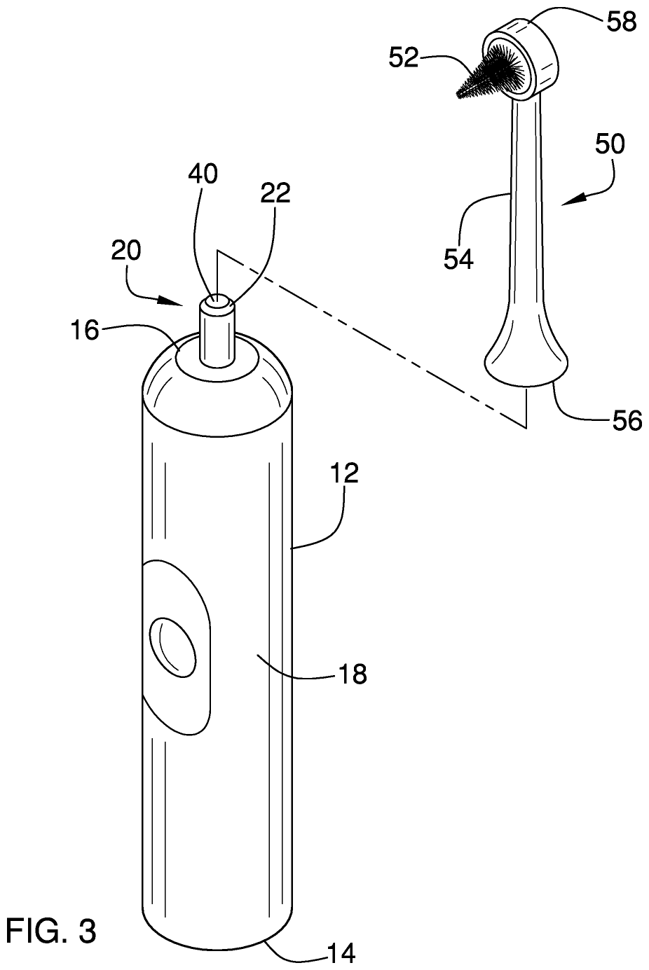

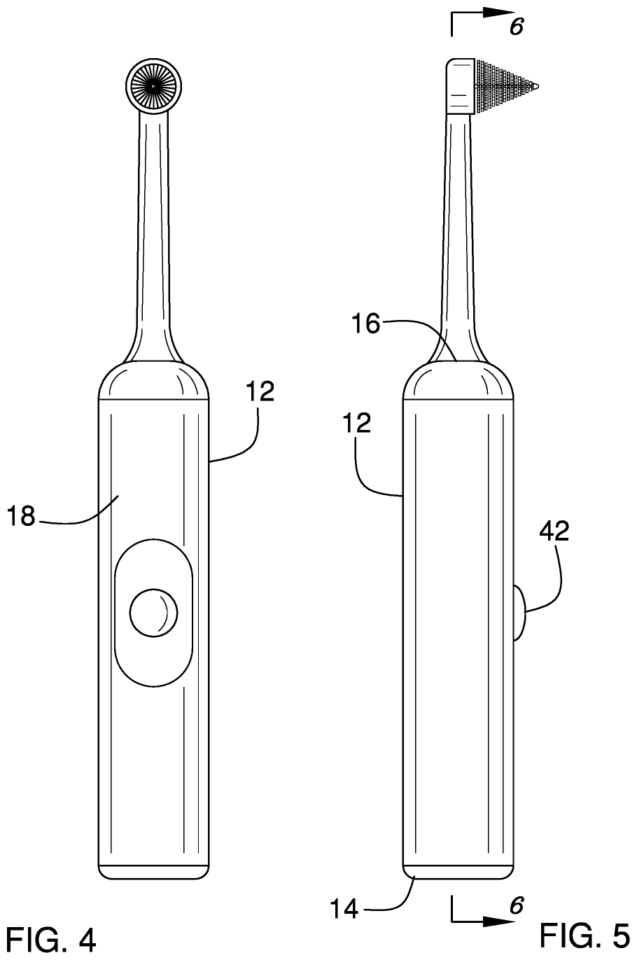

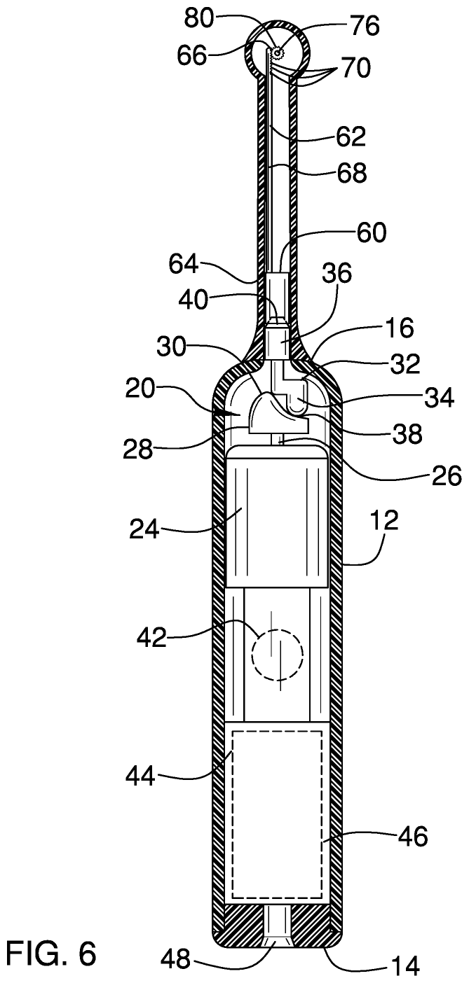

With reference now to the drawings, and in particular to FIGS. 1 through 6 thereof, a new toothbrush device embodying the principles and concepts of an embodiment of the disclosure and generally designated by the reference numeral 10 will be described.

As best illustrated in FIGS. 1 through 6, the automated toothbrush assembly generally comprises a handle 12 that is gripped for brushing teeth. The handle 12 has a bottom end 14, a top end 16 and an outer wall 18 extending therebetween, and the outer wall 18 is continuously arcuate about a line extending through the top end 16 and the bottom end 14 such that the handle 12 has a cylindrical shape. A rotation unit 20 is provided and the rotation unit 20 is movably positioned within the handle 12. The rotation unit 20 includes a drive shaft 22 extending outwardly through the handle 12 and the rotation unit 20 alternately rotates the drive shaft 22 in a first direction and a second direction when the rotation unit 20 is turned on.

The rotation unit 20 comprises a motor 24 that is positioned within the handle 12. The motor 24 has an output shaft 26 and the motor 24 rotates the output shaft 26 in a first direction when the motor 24 is turned on. The motor 24 may comprise an electric motor or the like. A cam 28 is rotatably coupled to the output shaft 26 such that the cam 28 is rotated when the motor 24 is turned on. The cam 28 has a lobe 30 extending upwardly therefrom and the lobe 30 is rotated about an axis extending through the output shaft 26 when the motor 24 is turned on.

The rotation unit 20 includes a lifter 32 which has a lower portion 34 that is offset with respect to an upper portion 36. The lower portion 34 has a lower end 38 and the upper portion 36 has an upper end 40. The lower end 38 is rounded and the lower end 38 rests on the cam 28. Moreover, the lower end 38 alternately rides upwardly and downwardly on the lobe 30 when the cam 28 is rotated. In this way the upper portion 36 travels upwardly and downwardly along a vertical axis when the cam 28 is rotated. The upper portion 36 extends upwardly through the top end 16 of the handle 12 such that the upper end 40 is exposed. Additionally, the upper portion 36 defines the drive shaft 22 of the rotation unit 20.

The rotation unit 20 includes a power button 42 that is movably coupled to the outer wall 18 of the handle 12 to be manipulated by a user. The power button 42 is electrically coupled to the motor 24 for tuning the motor 24 on and off. A power supply 44 is positioned within the handle 12 and the power supply 44 is electrically coupled to the power button 42. The power supply 44 comprises at least one rechargeable battery 46 that is positioned within the handle 12. The at least one rechargeable battery 46 is electrically coupled to the motor 24. The power supply 44 includes a charge port 48 that is recessed into the bottom end 14 of the handle 12 for receiving a charge cord. The charge port 48 is electrically coupled to the at least one rechargeable battery 46 for charging the at least one rechargeable battery 46.

A plurality of brushing heads 50 is provided and a respective one of the brushing heads 50 is removably attachable to the handle 12. In this way the respective brushing head 50 is in mechanical communication with the drive shaft 22 of the output unit. Each of the brushing heads 50 includes a brush 52 that has a conical shape to penetrate spaces between teeth.

Each of the brushing heads 50 comprises a stem 54 that has a lower end 56 and an upper end 58. The lower end 56 of the stem 54 is open, the stem 54 is hollow and the stem 54 flares outwardly adjacent to the lower end 56 of the stem 54. The lower end 38 of the stem 54 rests on the top end 16 of the handle 12 when the stem 54 is installed on the handle 12. Each of the brushing heads 50 includes a socket 60 that is rotatably positioned in the lower end 38 of the stem 54. The socket 60 engages the upper end 40 of the upper portion 36 of the lifter 32 when the stem 54 is positioned on the handle 12 for releasably retaining the stem 54 on the handle 12.

Each of the brushing heads 50 includes a rail gear 62 that has a bottom end 64, a top end 66 and a first surface 68 extending therebetween. The rail gear 62 is elongated between the top end 66 and the bottom end 64, and the first surface 68 has a plurality of teeth 70 being integrated therein. The plurality of teeth 70 extends from the top end 66 of the rail gear 62 toward the bottom end 64 of the rail gear 62. Additionally, the bottom end 64 of the rail gear 62 is coupled to the socket 60 having the rail gear 62 being vertically oriented in the stem 54.

The brush 52 has a brushing shaft 72 and a plurality of bristles 74 that is each coupled to and extends laterally away from the brushing shaft 72. The brushing shaft 72 extends through the stem 54 and the brushing shaft 72 has a first end 76 is positioned within the stem 54 and a second end 78 that is positioned outside of the stem 54. Additionally, the brushing shaft 72 extends along a line that is oriented perpendicular to the rail gear 62 and the brushing shaft 72 is positioned adjacent to the upper end 58 of the stem 54.

The plurality of bristles 74 extends between the second end 78 of the brushing shaft 72 and the stem 54, and the bristles 74 are distributed around a full circumference of the brushing shaft 72. Moreover, the plurality of bristles 74 decreases in length between the stem 54 and the second end 78 of the brushing shaft 72 thereby defining the conical shape of the brush 52. The bristles 74 may comprise a resiliently bendable material, including but not being limited to, rubber, silicone or plastic and the bristles 74 associated with each of the brushing heads 50 may have a stiffness ranging between soft and hard.

Each of the brushing heads 50 includes a gear 80 that is coupled to the first end 76 of the brushing shaft 72. The gear 80 engages the rail gear 62 and the rail gear 62 is urged upwardly and downwardly when the cam 28 is rotated. In this way the gear 80 is alternately rotated in a primary direction and a secondary direction when the rail gear 62 is urged upwardly and downwardly. This alternating rotation action facilitates the plurality of bristles 74 to brush the teeth.

In use, the chosen brushing head 50 is attached to the handle 12 and the power button 42 is depressed to turn on the rotation unit 20. Thus, the brush 52 on the brushing head 50 is continuously rotated back and forth for brushing teeth. Additionally, the conical shape of the brush 52 facilitates the brush 52 to reach into the spaces between teeth. The narrow end of the brush 52 can be inserted between teeth for cleaning between teeth in the convention of dental floss.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automated toothbrush assembly having a conical brushing head for cleaning between teeth, said assembly comprising:
a handle being gripped for brushing teeth;
a rotation unit being movably positioned within said handle, said rotation unit including a drive shaft extending outwardly through said handle, said rotation unit alternately rotating said drive shaft in a first direction and a second direction when said rotation unit is turned on; and
a plurality of brushing heads, a respective one of said brushing heads being removably attachable to said handle thereby facilitating said respective brushing head to be in mechanical communication with said drive shaft of said rotation unit, each of said brushing heads including a brush having a conical shape wherein said brush is configured to penetrate spaces between teeth.

2. The assembly according to claim 1, wherein said handle has a bottom end, a top end and an outer wall extending therebetween, said outer wall being continuously arcuate about a line extending through said top end and said bottom end such that said handle has a cylindrical shape.

3. The assembly according to claim 2, wherein said rotation unit comprises a motor being positioned within said handle, said motor having an output shaft, said motor rotating said output shaft in a first direction when said motor is turned on.

4. The assembly according to claim 3, wherein said rotation unit comprises a cam being rotatably coupled to said output shaft such that said cam is rotated when said motor is turned on, said cam having a lobe extending upwardly therefrom, said lobe being rotated about an axis extending through said output shaft when said motor is turned on.

5. The assembly according to claim 4, wherein said rotation unit comprises a lifter having a lower portion being offset with respect to an upper portion, said lower portion having a lower end, said upper portion having an upper end, said lower end being rounded, said lower end resting on said cam, said lower end alternately riding upwardly and downwardly on said lobe when said cam is rotated thereby facilitating said upper portion to travel upwardly and downwardly along a vertical axis when said cam is rotated.

6. The assembly according to claim 5, wherein said upper portion extends upwardly through said top end of said handle such that said upper end is exposed, said upper portion defining said drive shaft of said rotation unit.

7. The assembly according to claim 3, wherein said rotation unit includes a power button being movably coupled to said outer wall of said handle wherein said power button is configured to be manipulated by a user, said power button being electrically coupled to said motor for tuning said motor on and off.

8. The assembly according to claim 7, wherein said rotation unit includes a power supply being positioned within said handle, said power supply being electrically coupled to said power button, said power supply comprising:
at least one rechargeable battery being positioned within said handle, said at least one rechargeable battery being electrically coupled to said motor; and
a charge port being recessed into said bottom end of said handle wherein said charge port is configured to receive a charge cord, said charge port being electrically coupled to said at least one rechargeable battery for charging said at least one rechargeable battery.

9. The assembly according to claim 1, wherein each of said brushing heads comprises a stem having a lower end and an upper end, said lower end being open, said stem being hollow, said stem flaring outwardly adjacent to said lower end, said lower end resting on said top end of said handle.

10. The assembly according to claim 9, wherein:
said rotation unit includes a lifter having an upper portion, said upper portion having an upper end; and
each of said brushing heads includes a socket being rotatably positioned in said lower end of said stem, said socket engaging said upper end of said upper portion of said lifter when said stem is positioned on said handle for releasably retaining said stem on said handle.

11. The assembly according to claim 10, wherein each of said brushing heads includes a rail gear having a bottom end, a top end and a first surface extending therebetween, said rail gear being elongated between said top end and said bottom end, said first surface having a plurality of teeth being integrated therein, said plurality of teeth extending from said top end of said rail gear toward said bottom end of said rail gear, said bottom end of said rail gear being coupled to said socket having said rail gear being vertically oriented in said stem.

12. The assembly according to claim 11, said brush of each of said brushing heads has a brushing shaft and a plurality of bristles each being coupled to and extending laterally away from said brushing shaft, said brushing shaft extending through said stem, said brushing shaft having a first end being positioned within said stem and a second end being positioned outside of said stem, said plurality of bristles extending between said second end of said brushing shaft and said stem, said plurality of bristles being distributed around a full circumference of said brushing shaft, said plurality of bristles decreasing in length between said stem and said second end of said brushing shaft to define said conical shape of said brush.

13. The assembly according to claim 12, wherein each of said brushing heads includes a gear being coupled to said first end of said brushing shaft, said gear engaging said rail gear, said rail gear being urged upwardly and downwardly when said cam is rotated, said gear alternately being rotated in a primary direction and a secondary direction when said rail gear is urged upwardly and downwardly wherein said plurality of bristles is configured to brush teeth.

14. An automated toothbrush assembly having a conical brushing head for cleaning between teeth, said assembly comprising:
a handle being gripped for brushing teeth, said handle having a bottom end, a top end and an outer wall extending therebetween, said outer wall being continuously arcuate about a line extending through said top end and said bottom end such that said handle has a cylindrical shape;
a rotation unit being movably positioned within said handle, said rotation unit including a drive shaft extending outwardly through said handle, said rotation unit alternately rotating said drive shaft in a first direction and a second direction when said rotation unit is turned on, said rotation unit comprising:
a motor being positioned within said handle, said motor having an output shaft, said motor rotating said output shaft in a first direction when said motor is turned on;
a cam being rotatably coupled to said output shaft such that said cam is rotated when said motor is turned on, said cam having a lobe extending upwardly therefrom, said lobe being rotated about an axis extending through said output shaft when said motor is turned on;
a lifter having a lower portion being offset with respect to an upper portion, said lower portion having a lower end, said upper portion having an upper end, said lower end being rounded, said lower end resting on said cam, said lower end alternately riding upwardly and downwardly on said lobe when said cam is rotated thereby facilitating said upper portion to travel upwardly and downwardly along a vertical axis when said cam is rotated, said upper portion extending upwardly through said top end of said handle such that said upper end is exposed, said upper portion defining said drive shaft of said rotation unit;
a power button being movably coupled to said outer wall of said handle wherein said power button is configured to be manipulated by a user, said power button being electrically coupled to said motor for tuning said motor on and off; and
a power supply being positioned within said handle, said power supply being electrically coupled to said power button, said power supply comprising:
at least one rechargeable battery being positioned within said handle, said at least one rechargeable battery being electrically coupled to said motor; and
a charge port being recessed into said bottom end of said handle wherein said charge port is configured to receive a charge cord, said charge port being electrically coupled to said at least one rechargeable battery for charging said at least one rechargeable battery; and
a plurality of brushing heads, a respective one of said brushing heads being removably attachable to said handle thereby facilitating said respective brushing head to be in mechanical communication with said drive shaft of said rotation unit, each of said brushing heads including a brush having a conical shape wherein said brush is configured to penetrate spaces between teeth, each of said brushing heads comprising:
a stem having a lower end and an upper end, said lower end being open, said stem being hollow, said stem flaring outwardly adjacent to said lower end, said lower end resting on said top end of said handle;
a socket being rotatably positioned in said lower end of said stem, said socket engaging said upper end of said upper portion of said lifter when said stem is positioned on said handle for releasably retaining said stem on said handle;
a rail gear having a bottom end, a top end and a first surface extending therebetween, said rail gear being elongated between said top end and said bottom end, said first surface having a plurality of teeth being integrated therein, said plurality of teeth extending from said top end of said rail gear toward said bottom end of said rail gear, said bottom end of said rail gear being coupled to said socket having said rail gear being vertically oriented in said stem;
said brush having a brushing shaft and a plurality of bristles each being coupled to and extending laterally away from said brushing shaft, said brushing shaft extending through said stem, said brushing shaft having a first end being positioned within said stem and a second end being positioned outside of said stem, said plurality of bristles extending between said second end of said brushing shaft and said stem, said plurality of bristles being distributed around a full circumference of said brushing shaft, said plurality of bristles decreasing in length between said stem and said second end of said brushing shaft to define said conical shape of said brush; and
a gear being coupled to said first end of said brushing shaft, said gear engaging said rail gear, said rail gear being urged upwardly and downwardly when said cam is rotated, said gear alternately being rotated in a primary direction and a secondary direction when said rail gear is urged upwardly and downwardly wherein said plurality of bristles is configured to brush teeth.
